(19) United States
(12) Patent Application Publication
(10) Pub. No.: US 2025/0370412 A1
(43) Pub. Date: Dec. 4, 2025

(54) ESCAPEMENT DEVICE FOR A TIMEPIECE

(71) Applicant: Rolex SA, Genève 26 (CH)

(72) Inventors: Fabiano COLPO, Lausanne (CH); Olivier KARLEN, Blonay (CH); Mai Xuan TU, Ecublens (CH)

(21) Appl. No.: 19/226,091

(22) Filed: Jun. 2, 2025

(30) Foreign Application Priority Data
Jun. 3, 2024 (EP) 24179730.7

(51) Int. Cl. G04B 15/14; G04B 15/06

(52) U.S. Cl. CPC G04B 15/14; G04B 15/06

(57) ABSTRACT

The invention relates to an escapement device of a timepiece that includes a first escape wheel, pivotally mounted about a first axis of rotation, comprising a toothing equipped with first teeth and with second teeth, and a second escape wheel, pivotally mounted about a second axis of rotation, comprising a toothing arranged to at least cooperate with the second teeth of the first escape wheel. Each second tooth of the first escape wheel has an arm shape comprising at least one extreme protrusion arranged to cooperate with the toothing of the second escape wheel.

### CROSS-REFERENCE TO RELATED APPLICATIONS

The present application claims priority to European Application No. 24179730.7 filed with the European Patent Office on Jun. 3, 2024, which is incorporated herein by reference in its entirety for all purposes.

### TECHNICAL FIELD OF THE INVENTION

The present invention generally relates to an escapement device for a mechanical timepiece. Particularly, the present invention relates to an escapement device comprising two escape wheels. According to one aspect, the present invention may relate to an escapement device comprising escape wheels provided to give impulses, particularly tangential impulses, to a blocking mobile element of the escapement device for a mechanical timepiece.

### STATE OF THE ART

In the prior art of the escapement devices, it is known to propose, as shown in Application EP4198641, a natural escapement comprising two escape wheels each provided to cooperate on the one hand with an articulated anchor, and on the other hand with impulse pallets provided on the balance to ensure direct cooperation with either of the two escape wheels. However, such an escapement device is bulky and comprises a complex mechanism.

### DISCLOSURE OF THE INVENTION

One aim of the present invention is to address the drawbacks of the prior art mentioned above and particularly, first of all, to propose an escapement device (or more specifically an escape wheel), that is compact, and/or devoid of complex pieces to manufacture and/or assemble, and/or robust, and/or that has high operating efficiency.

To this end, a first aspect of the invention relates to an escapement device of a timepiece, arranged to receive a drive force from a drive train of the timepiece and transmit impulses to maintain oscillations of an oscillator of the timepiece, the escapement device comprising:
a first escape wheel, pivotally mounted about a first axis of rotation, comprising a toothing equipped with first teeth arranged to at least transmit the impulses to maintain the oscillations of the oscillator, and with second teeth,
a second escape wheel, pivotally mounted about a second axis of rotation, comprising a toothing arranged to at least transmit the impulses to maintain the oscillations of the oscillator and to cooperate with the second teeth of the first escape wheel,
characterized in that each second tooth of the first escape wheel has an arm shape comprising at least one extreme protrusion arranged to cooperate with the toothing of the second escape wheel.

According to the implementation above, the escapement device comprises a first escape wheel which comprises a toothing with first teeth and second teeth different from the first teeth (in shape and/or in size and/or in number). The first teeth are arranged or provided to cooperate at least with a blocking mobile element (typically to participate in blocking and/or transmitting an impulse). The second teeth are arranged or provided to cooperate with the toothing of the second escape wheel (typically to participate in driving and/or blocking the second escape wheel). For this purpose, each second tooth of the first escape wheel has an arm or branch shape comprising at least one extreme protrusion which allows each second tooth to cooperate with the toothing of the second escape wheel via its end, which makes it possible to minimize the inertia while making it possible to provide a large number of first and/or second teeth. Thus, the remainder of the second teeth, namely the remaining portions or conformations of the second teeth, may have a minimal size. Accordingly, the fact that each second tooth of the first escape wheel has at least one extreme protrusion that allows each second tooth to cooperate with the second escape wheel makes it possible to maximize the thickness of the first escape teeth and/or minimize the thickness of the second teeth and/or maximize the number of escape teeth.

The escapement device may be defined by the following characteristics, taken individually or in combination.

According to one embodiment, the toothing of the second escape wheel comprises first teeth arranged to at least transmit the impulses to maintain the oscillations of the oscillator, and second teeth arranged to cooperate with the toothing of the first escape wheel, and each second tooth of the second escape wheel has an arm shape comprising at least one extreme protrusion arranged to cooperate with the toothing of the first escape wheel.

According to one embodiment:
the second teeth of the first escape wheel are arranged to cooperate with the first teeth of the second escape wheel, the cooperation between a second tooth of the first escape wheel and a first tooth of the second escape wheel occurring exclusively or solely by the extreme protrusion of said second tooth of the first escape wheel, and/or
the second teeth of the second escape wheel are arranged to cooperate with the first teeth of the first escape wheel, the cooperation between a second tooth of the second escape wheel and a first tooth of the first escape wheel occurring exclusively or solely by the extreme protrusion of said second tooth of the second escape wheel. In other words, the remainder of the second teeth, namely the remaining portions or conformations of the second teeth, of the first escape wheel or of the second escape wheel do not cooperate with the first teeth respectively of the second escape wheel or of the first escape wheel. Accordingly, the shape and/or size and/or dimension of the remainder of the second teeth can be adjusted without taking into account the cooperation with the first teeth.

According to one embodiment:
the extreme protrusion of each second tooth of the first escape wheel is provided to cooperate exclusively with the first teeth of the second escape wheel, and/or
the extreme protrusion of each second tooth of the second escape wheel is provided to cooperate exclusively with the first teeth of the first escape wheel. In other words, the remainder of the second teeth, namely the remaining portions or conformations of the second teeth, of the first escape wheel or of the second escape wheel do not cooperate with the first teeth respectively of the second escape wheel or of the first escape wheel, and the extreme protrusions of the second teeth of the first escape wheel or of the second escape wheel only cooperate with the first teeth respectively of the second escape wheel or of the first escape wheel. Accordingly, the shape, size and dimension of the remainder of the second teeth can be adjusted without taking into account the cooperation with the first teeth, and the shape, size, and dimension of the extreme protrusions of the second teeth has no influence on the other components or parts of the escapement device.

According to one embodiment, the escapement device comprises a blocking mobile element provided to:
reversibly block the rotation of the first escape wheel and/or of the second escape wheel,
receive the impulses from the first escape wheel and/or from the second escape wheel to transmit them to the oscillator and thus maintain the oscillations of said oscillator. In other words, the blocking mobile element is arranged between each of the escape wheels and the oscillator. Accordingly, according to one embodiment, the escapement device is an indirect impulse device: the escape wheels do not cooperate directly with the oscillator.

According to one embodiment:
the first teeth of the first escape wheel have tips that cooperate exclusively with the blocking mobile element,
the first teeth of the second escape wheel have tips that cooperate exclusively with the blocking mobile element.

According to one embodiment, each at least one extreme protrusion of each of the second teeth of the first escape wheel has a first engagement portion arranged to come into contact with the toothing of the second escape wheel during the cooperation of each second tooth of the first escape wheel with the toothing of the second escape wheel,
and each first engagement portion is arranged between two circles of diameter DTDD1 and 0.94.DTDD1, preferably between two circles of diameter DTDD1 and 0.96. DTDD1, preferably between two circles of diameter DTDD1 and 0.98.DTDD1, DTDD1 being a head circle diameter of the second teeth of the first escape wheel. In other words, each extreme protrusion and/or each first engagement portion is arranged at the end of the second teeth, or close to the end of the second teeth.

According to one embodiment, each first engagement portion comprises:
at least one rounded, preferably convex and/or protruding, surface and/or
at least one planar surface, and/or
at least one ridge, and/or
a tip shape.

According to one embodiment, each second tooth of the first escape wheel has at least one second engagement portion provided to come into contact with the toothing of the second escape wheel during the cooperation of each second tooth of the first escape wheel with the toothing of the second escape wheel,
and the second engagement portions are arranged at least partially between two circles of diameter DTDD1 and 0.50.DTDD1, preferably between two circles of diameter 0.95.DTDD1 and 0.60.DTDD1, preferably between two circles of diameter 0.90.DTDD1 and 0.70.DTDD1, DTDD1 being a head circle diameter of the second teeth of the first escape wheel. Accordingly, each second engagement portion is arranged closer to the center of the escape wheel than each first engagement portion.

According to one embodiment, each second engagement portion comprises at least one convex contact surface. According to one embodiment, each second engagement portion may comprise an involute portion of a circle.

According to one embodiment, each second tooth of the first escape wheel has a first flank and a second flank opposite to each other, and said at least one extreme protrusion is arranged on or on the side of the first flank, and said at least one second engagement portion is arranged on or on the side of the second flank.

According to one embodiment, each second tooth of the first arm-shaped escape wheel has:
a second tooth foot defining a second tooth foot diameter DPDD1,
a second tooth thickness EDD1,
a second tooth top defining a second tooth head circle diameter DTDD1, and, from the second tooth foot to the second tooth top, the second tooth thickness EDD1 varies by less than 40%, preferably by less than 30%, preferably by less than 20% relative to a second tooth thickness EDDPr1 measured at an average second tooth diameter DPrDD1 defined by:

$$DPrDD 1 = ( DPDD 1 + DTDD 1 ) / 2$$

According to the implementation above, each second tooth of the first escape wheel may have a branch or arm shape or even a beam shape having a free end and with a constant thickness or which varies by less than 40%, preferably by less than 30%, preferably by less than 20% relative to an average thickness (for example the average of the thicknesses measured along the second tooth).

According to one embodiment, each first tooth of the first escape wheel has:
a first tooth foot defining a first tooth foot diameter DPPD1,
a first tooth thickness EPD1,
a first tooth top defining a first tooth head circle diameter DTPD1, and, from the first tooth foot to the first tooth top, the first tooth thickness EPD1 varies by at least 40%, preferably by at least 50%, preferably by at least 80% relative to a first tooth thickness EPDPr1 measured at an average first tooth diameter DPrPD1 defined by:

$$DPrPD 1 = ( DPPD 1 + DTPD 1 ) / 2$$

According to the implementation above, each first tooth may have at least one involute portion of a circle.

According to one embodiment, the second tooth foot diameter DPDD1 is equal or substantially equal to the first tooth foot diameter DPPD1. According to one alternative embodiment, the second tooth foot diameter DPDD1 may be different from the first tooth foot diameter DPPD1.

According to one embodiment, the first tooth thickness EPDPr1 measured at the average first tooth diameter DPrPD1 is strictly greater than the second tooth thickness EDDPr1 measured at the average second tooth diameter DPrDD1, and preferably 3. EDDPr1<EPDPr1, and preferably 3.5. EDDPr1<EPDPr1.

According to one embodiment, the second teeth of the first escape wheel are arranged in pairs between the first teeth of the first escape wheel. In other words, two adjacent second teeth are arranged between two successive first teeth.

According to one embodiment, each second tooth of the first escape wheel has the shape of an arm curved according to a radius of curvature of the second tooth.

According to one embodiment, the radii of curvature of two adjacent second teeth of the first escape wheel are opposite to each other. In other words, if a second tooth is curved according to the clockwise direction of the escape wheel, a second adjacent tooth is curved along the counterclockwise direction of the escape wheel.

According to one embodiment, two adjacent second teeth of the first escape wheel have a U-shape or a horseshoe-shape. According to one embodiment, the U-shape or horseshoe shape of two adjacent second teeth is provided to receive a first tooth of the second escape wheel.

According to one embodiment, two adjacent second teeth of the first escape wheel are symmetrical relative to a plane of symmetry comprising the first axis of rotation of the first escape wheel.

According to one embodiment, the first escape wheel comprises:
between 10 and 14 second teeth, preferably 12 second teeth, and/or
between 5 and 7 first teeth, preferably 6 first teeth.

According to one embodiment, the first tooth head diameter DTPD1 is strictly greater than the second tooth head diameter DTDD1.

According to one embodiment, the first tooth head diameter DTPD1 of the first wheel is substantially equal to or equal to the first tooth head diameter DTPD2 of the second wheel.

According to one embodiment, the toothing of the first escape wheel is identical to the toothing of the second escape wheel. According to one embodiment, the first escape wheel is identical to the second escape wheel.

According to one embodiment, the extreme protrusion is oriented and/or forms a protrusion along a direction tangential to a circle centered on the first axis of rotation of the first escape wheel and passing through the extreme protrusion.

A second aspect of the invention may relate to an escape wheel for an escapement device of a timepiece, arranged to:
receive a drive force from a drive train of the timepiece,
transmit impulses to maintain oscillations of an oscillator of the timepiece,
cooperate with a blocking mobile element of the escapement device,
form a first escape wheel of the escapement device, pivotally mounted about a first axis of rotation, and cooperating with another escape wheel forming a second escape wheel of the escapement device pivoting about a second axis of rotation and comprising a toothing,
the escape wheel comprising a toothing comprising:
first teeth, arranged to cooperate at least with the blocking mobile element;
second teeth, arranged to cooperate with the toothing of the second escape wheel,
characterized in that each second tooth has the shape of an arm comprising at least one extreme protrusion arranged to cooperate with the toothing of the second escape wheel.

A third aspect of the invention may relate to an escape wheel of an escapement device of a timepiece, arranged to:
receive a drive force from a drive train of the timepiece,
transmit impulses to maintain oscillations of an oscillator of the timepiece,
cooperate with a blocking mobile element of the escapement device,
form a first escape wheel of the escapement device, pivotally mounted about a first axis of rotation, and cooperating with another escape wheel forming a second escape wheel of the escapement device and comprising a toothing,
the escape wheel comprising a toothing comprising:
first teeth, arranged to cooperate at least with the blocking mobile element;
second teeth, arranged to cooperate with first teeth and/or with the toothing of the second escape wheel,
characterized in that each second tooth has the shape of an arm curved along a radius of curvature, the radii of curvature of two adjacent second teeth being opposite to each other. In other words, for a pair formed by two adjacent second teeth, a first second tooth is curved along a first direction of rotation or along a first tangential direction, and a second tooth is curved along a second direction of rotation or along a second tangential direction (respectively opposite to the first direction of rotation or to the first tangential direction).

According to one embodiment, two adjacent second teeth have a U-shape or a horseshoe shape.

According to one embodiment, the toothing of the second escape wheel comprises first teeth and second teeth,
and, when a second tooth of the second escape wheel cooperates with a first tooth of the toothing of the first escape wheel, said second tooth of the second escape wheel has an inner face facing said first tooth of the toothing of the first escape wheel, and the inner face of said second tooth of the second escape wheel has a radius of curvature smaller than a radius of curvature of said first tooth of the toothing of the first escape wheel. Generally, when a second tooth of an escape wheel cooperates with a first tooth of the toothing of the other escape wheel, said second tooth of said escape wheel has an inner face facing said first tooth of the toothing of the other escape wheel, and the inner face of said second tooth of said escape wheel has a radius of curvature smaller than a radius of curvature of said first tooth of the toothing of the other escape wheel.

According to one embodiment, the toothing of the second escape wheel comprises first teeth and second teeth,
and, when a second tooth of the second escape wheel cooperates with a first tooth of the toothing of the first escape wheel, said second tooth of the second escape wheel has an inner face facing said first tooth of the toothing of the first escape wheel, and the inner face of said second tooth of the second escape wheel has a center of curvature arranged on the same side of the inner face as a center of curvature of said first tooth of the toothing of the first escape wheel. Generally, when a second tooth of an escape wheel cooperates with a first tooth of the toothing of the other escape wheel, said second tooth of said escape wheel has an inner face facing said first tooth of the toothing of the other escape wheel,
and the inner face of said second tooth of said escape wheel has a center of curvature arranged on the same side of the inner face as a center of curvature of said first tooth of the toothing of the other escape wheel.

According to one embodiment, the inner face of said second tooth of the second escape wheel is concave, and said first tooth of the toothing of the first escape wheel is convex. Generally, the inner face of the second teeth of each escape wheel are concave, to cooperate with the first convex teeth of the first teeth of the other escape wheel.

A fourth aspect of the invention may relate to a timepiece, comprising an escapement device according to the first aspect.

### DESCRIPTION OF THE FIGURES

Other characteristics and advantages of the present invention will become more clearly apparent upon reading the following detailed description of embodiment(s) of the invention given as non-limiting examples and illustrated by the appended drawings, in which:

FIG. 1 represents an overall view of an escapement device comprising in particular a first escape wheel, a second escape wheel and a blocking mobile element;

FIG. 2a represents a front view of the first escape wheel of FIG. 1;

FIG. 2b represents a detail of the first escape wheel of FIG. 2a;

FIG. 3a represents a front view of the second escape wheel of FIG. 1;

FIG. 3b represents a detail of the second escape wheel of FIG. 3a;

FIG. 4 represents a side view of the first escape wheel of FIG. 2 or of the second escape wheel of FIG. 3;

FIG. 5 represents a first phase of meshing the first escape wheel of FIG. 2 with the second escape wheel of FIG. 3;

FIG. 6 represents a second phase of meshing the first escape wheel of FIG. 2 with the second escape wheel of FIG. 3;

FIG. 7 represents a third phase of meshing the first escape wheel of FIG. 2 with the second escape wheel of FIG. 3;

FIG. 8 represents variant embodiments of teeth of the first escape wheel and/or of the second escape wheel.

### DETAILED DESCRIPTION OF EMBODIMENT(S)

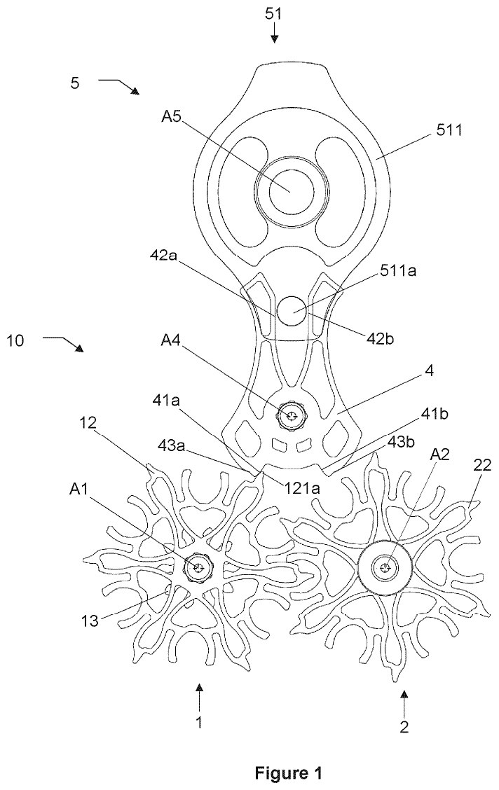

FIG. 1 illustrates an overall view of an escapement device 10 cooperating with a balance 51 of an oscillator 5 (not represented, but whose balance plate 511 is represented), the escapement device 10 comprising in particular:
a first escape mobile element 1,
a second escape mobile element 2,
a blocking mobile element 4.

As shown in FIG. 1:
the first escape mobile element 1 is movable in rotation about a first axis of rotation A1 and comprises a first pinion 13 (provided to be engaged with a drive train of the timepiece) and a first escape wheel 12 which can typically be driven onto a first rotation shaft,
the second escape mobile element 2 is movable in rotation about a second axis of rotation A2 and comprises a second escape wheel 22 which can typically be driven onto a second rotation shaft,
the blocking mobile element 4 is pivoted about a fourth axis of rotation A4, and comprises first and second impulse means 42a, 42b,
the balance plate 511 is mounted in rotation about a fifth axis of rotation A5 and comprises a pin 511a typically provided to cooperate with the first and second impulse means 42a, 42b of the blocking mobile element 4.

During operation, the first escape wheel 12 and the second escape wheel 22 are alternately in contact with the pivoted blocking mobile element 4, and the first and second impulse means 42a, 42b are provided to cooperate with the pin 511a of the balance plate 511, so as to give the impulses or allow the release of the balance 51. Advantageously, the toothing of the first escape wheel 12 and the toothing of the second escape wheel 22 are identical. Particularly, the first escape wheel 12 and the second escape wheel 22 are identical, the second escape wheel 22 being simply mounted upside down relative to the first escape wheel 12. The first escape mobile element 1 further comprises the pinion 13, coaxial with the first escape wheel 12, which is engaged with a mobile element of a drive train not represented.

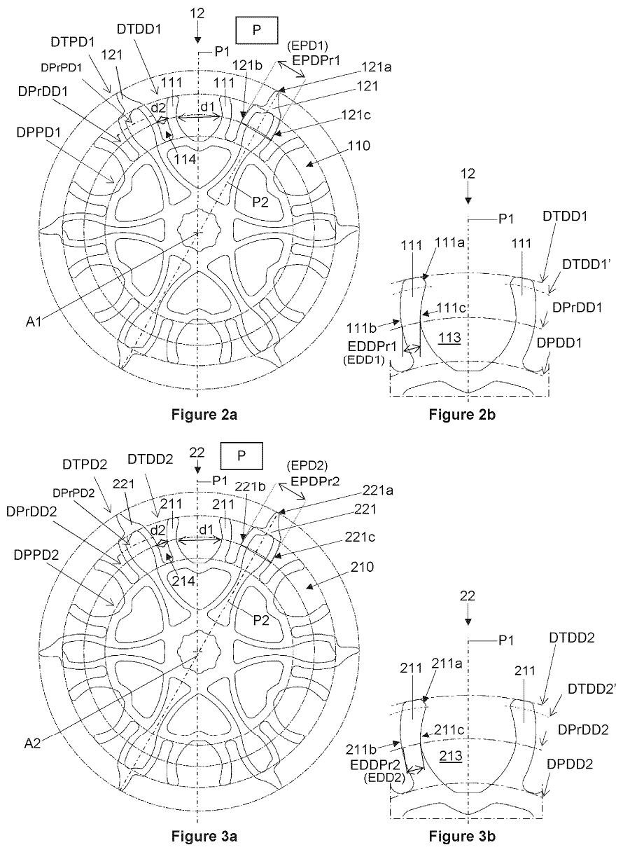

As shown in FIG. 2a, the first escape wheel 12 comprises a toothing comprising:
first teeth 121, arranged to cooperate at least with the blocking mobile element 4 as will be explained below;
second teeth 111, arranged to cooperate with the toothing of the second escape wheel 22 as will be explained below.

As shown in FIG. 3a, the second escape wheel 22 comprises a toothing comprising:
first teeth 221, arranged to cooperate at least with the blocking mobile element 4 as will be explained below;
second teeth 211, arranged to cooperate with the toothing of the first escape wheel 12 as will be explained below.

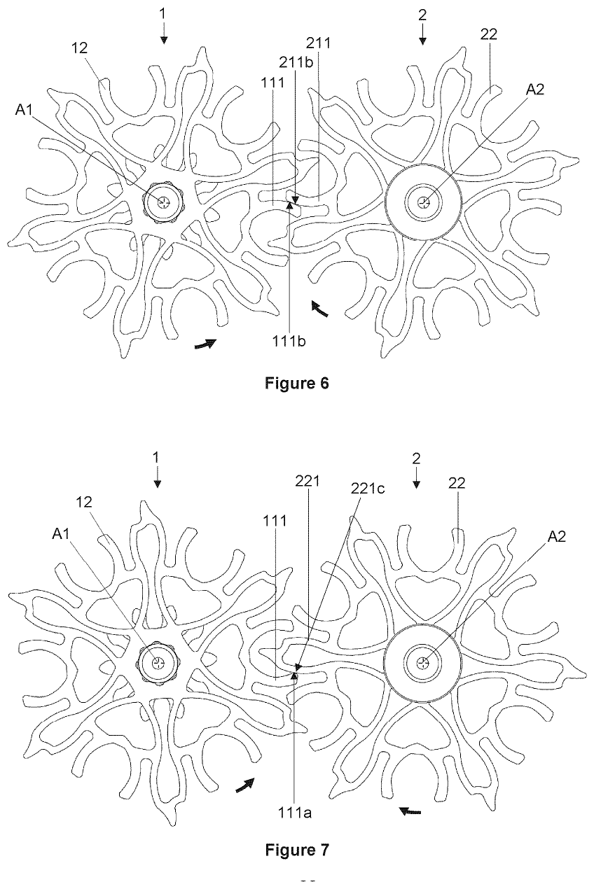

The first teeth 121; 221 respectively of the first escape wheel 12 and of the second escape wheel 22 are respectively provided to cooperate by contact with impulse means 41a; 41b and blocking means 43a; 43b of the blocking mobile element 4. These same first teeth 121; 221 respectively of the first escape wheel 12 and of the second escape wheel 22 are also provided to cooperate by contact with the second teeth 211; 111 respectively of the second escape wheel 22 and of the first escape wheel 12 as will be explained in detail in the passages corresponding to FIGS. 5 to 7.

FIGS. 2a and 3a respectively illustrate a general view of the first escape wheel 12 and of the second escape wheel 22, and FIGS. 2b and 3b illustrate respectively a detailed view of the second teeth 111, 211 respectively of the first escape wheel 12 and of the second escape wheel 22.

The first escape wheel 12 and the second escape wheel 22 being similar, only FIGS. 2a and 2b are described in detail below.

FIG. 2a shows in particular the second teeth 111 extending from a second tooth foot diameter DPDD1 to a second tooth head diameter DTDD1. The first teeth 121 extend from the second tooth foot diameter DPDD1 to a first tooth head diameter DTPD1. These first teeth 121 each comprise escapement means 121a, particularly escapement surfaces 121a at the first tooth head diameter DTPD1. These means 121a form tips 121a. It is these tips 121a that cooperate with the impulse means 41a or the blocking means 43a of the blocking mobile element 4. It can be noted particularly that FIG. 1 illustrates the first escape wheel 12 rotating in the counterclockwise direction, and giving, via a tip 121a, a tangential impulse to the impulse means 41a of the blocking mobile element 4.

Also, the first tooth head diameter DTPD1 is strictly greater than the second tooth head diameter DTDD1.

The first teeth 121 and the second teeth 111 are arranged in the same plane P. Particularly, two second teeth 111 are arranged between two successive first teeth 121. The space separating two successive second teeth 111 defines a housing 113 within which a first tooth 221 of the second escape wheel 22 is capable of being housed during the meshing of the first escape wheel 12 with the second escape wheel 22.

The second teeth 111 have a thickness EDDPr1 substantially smaller than the thickness EPDPr1 of the first teeth 121 for example at an average second tooth diameter DPrDD1 on which an arc is located equidistant from arcs of second tooth foot diameter DPDD1 and second tooth head diameter DTDD1.

Particularly 3.EDDPr1≤EPDPr1, or even 3.5.EDDPr1≤EPDPr1.

A distance d1 separating two second teeth 111 at the average second tooth diameter DPrDD1, or in other words the extent d1 of the housing 113 at the average second tooth diameter DPrDD1, is strictly greater than the thickness EPDPr1 of the first teeth 121. Particularly, 1.2.EPDPr1≤d1, or even 1.3.EPDPr1≤d1 can be provided.

The second teeth 111 each have an extreme protrusion 111a (for example in the form of a tip), arranged at the second tooth head diameter DTDD1, which is provided to cooperate by contact with a first tooth 221 of the second escape wheel 22, particularly with a flank 221b or 221c of a first tooth 221 of the second escape wheel 22.

In one specific embodiment, these extreme protrusions 111a are in the form of rounded surfaces in the continuity of the inner flanks 111c of the second teeth 111, which also constitute the walls of the housing 113. Particularly, these extreme protrusions 111a extend from the second tooth head diameter DTDD1 to an intermediate second tooth diameter DTDD1′ with DTDD1′<DTDD1, in particular 1.05.DTDD1′≤DTDD1, or even 1.04.DTDD1′≤DTDD1, or even 1.02.DTDD1′≤DTDD1.

Alternatively to the shape of FIG. 1, these extreme protrusions 111a could be in the form of a combination of at least one rectilinear surface and/or of at least one curved surface, which may or may not form a continuous surface. Alternatively again, these extreme protrusions 111a could be exclusively in the form of rectilinear surfaces. Alternatively again, these extreme protrusions 111a could be in the form of ridges.

These extreme protrusions 111a are arranged at the second tooth head diameter DTDD1. They form part of the head of the second teeth 111 or constitute the heads of the second teeth 111 in the case where DTDD1′˜DTDD1, or even DTDD1′=DTDD1.

Advantageously, the inner flanks 111c are not functional, only the extreme protrusions 111a being functional to allow the driving of a first tooth or vice versa. Thus, the inner flanks 111c can be shaped so as to maximize the dimension of the housing 113 and/or minimize the thickness EDDPr1 of the second teeth 111.

Thus, in one specific embodiment, the second teeth 111 are curved, and the inner flanks 111c are thus advantageously set back from the flanks 221b, 221c of a first tooth 221 of the second escape wheel 22 during the meshing of the first and second escape wheels 12, 22. Particularly, the second teeth 111 are concave when viewed from the housing 113, unlike a conventional tooth whose protrusion is ogive-shaped and whose flanks are convex when viewed from a space between two successive second teeth (FIG. 2b or 3b). Preferably, the second teeth 111 are symmetrical with respect to a plane P1 passing through the first pivot axis A1 of the first escape wheel 12.

Each of the second teeth 111 is also equipped with a functional flank 111b to allow the driving of a second tooth 211 of the second escape wheel 22, particularly to allow the driving by contact with a functional flank 211b of another second tooth 211.

These functional flanks 111b extend from the second tooth foot diameter DPDD1 to the second tooth head diameter DTDD1. These functional flanks 111b are convex when viewed from a space between a second tooth 111 and a first tooth 121, in the manner of a flank of a conventional tooth. This space defines a housing 114. The distance d2 separating a second tooth 111 from a first tooth 121 at the average second tooth diameter DPrDD1, or in other words the extent d2 of the housing 114 at the average second tooth diameter DPrDD1, is strictly greater than the thickness EDDPr1 of the first teeth 121.

Particularly 1.1.EDDPr1≤d2, or even 1.2.EDDPr1≤d2.

Each of the first teeth 121 comprises, for its part, functional flanks 121b, 121c which extend between the second tooth foot diameter DPDD1 and the second tooth head diameter DTDD1. Particularly, these flanks 121b, 121c are convex when viewed from a space between a second tooth and a first tooth, and are symmetrical with respect to a plane P2 passing through the first pivot axis A1 of the first escape wheel 12, in the manner of a conventional tooth. These flanks are exclusively dedicated to the meshing function of the first and second escape wheels 12 and 22. The first tooth portion 121 comprised between the second tooth head diameter DTDD1 and the first tooth head diameter DTPD1, which ends with the tip 121a, is dedicated exclusively to the escapement function.

In the non-limiting particular example represented, the second escape wheel 22 has the same characteristics as those of the first escape wheel 12. The numerical references relating to the characteristics begin with a “2” instead of the “1” of the numerical references relating to the characteristics of the first escape wheel 12, as represented in FIGS. 3a and 3b. The alphabetical references relating to the diameters or to the thicknesses or dimensions end with a “2” instead of the “1” of the alphabetical references relating to the diameters or to the thicknesses or dimensions of the first escape wheel 12.

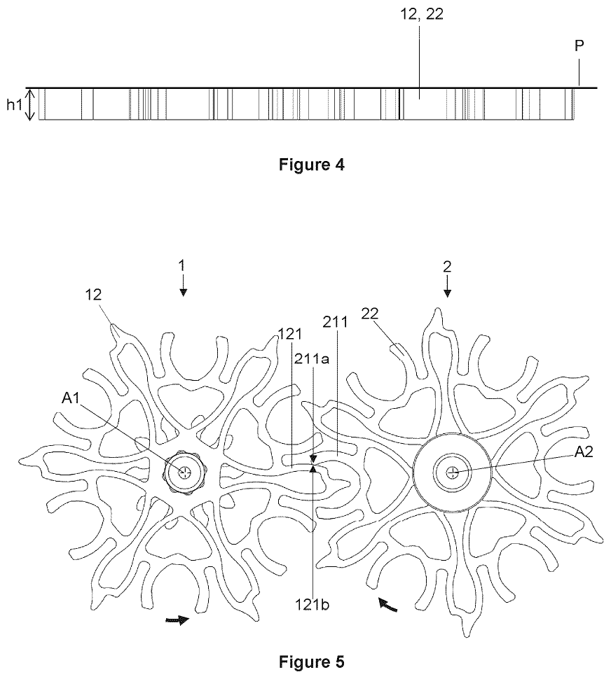

FIG. 4 represents a front view of a first escape wheel 12 or of a second escape wheel 22. This wheel advantageously has a single level extending over a plane P, and has a constant height h1. The thickness EDDPr1 of the second teeth 111 (and/or the thickness EDDPr2 of the second teeth 211) is smaller than the height h1, or even much smaller than the thickness h1. Particularly, 1.5.EDDPr1≤h1.

FIGS. 5 to 7 illustrate different phases of meshing the first escape wheel 12 with the second escape wheel 22.

FIG. 5 shows the first escape wheel 12 rotating in the counterclockwise direction about its first axis of rotation A1 and driving the second escape wheel 22 in the clockwise direction about its second axis of rotation A2. This meshing is first performed by means of a first tooth 121 of the first escape wheel 12, a flank 121b of which acts by contact against a protrusion 211a of a second tooth 211 of the second escape wheel 22. The contact between this first tooth 121 and the second tooth 211 is performed exclusively by the flank 121b of the first tooth 121 and the protrusion 211a of the second tooth 211.

FIG. 6 shows the sequence that follows that of FIG. 5, with a second tooth 111 of the first escape wheel 12 which acts by contact against a second tooth 211 of the second escape wheel 22. Particularly, the flank 111b of the second tooth 111 of the first escape wheel 12 drives the flank 211b of the second tooth 211 of the second escape wheel 22.

FIG. 7 shows the sequence following that of FIG. 6, with a second tooth 111 of the first escape wheel 12, successive to the engaged second tooth 111 of FIG. 6, the protrusion 111a of which acts by contact against a flank 221c of a first tooth 221 of the second escape wheel 22.

These different sequences are repeated in order to allow the driving of the second escape wheel 22 by the first escape wheel 12.

In one specific embodiment, the first escape wheel 12 and the second escape wheel 22 each comprise 6 first teeth 121, 221, and 6 pairs of second teeth 111; 211. Naturally, these numbers may differ depending on the desired escapement version.

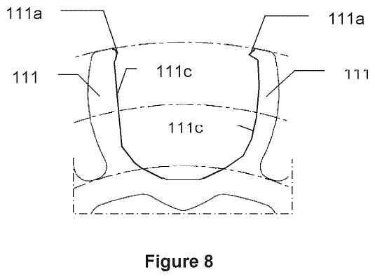

FIG. 8 represents variant embodiments of the second teeth 111, with:
on the left of FIG. 8 a first variant embodiment in which the second tooth 111 has an inner flank 111c with a rectilinear or planar and non-curved portion, as in FIG. 2b or 3b,
on the right of FIG. 8 a second variant embodiment in which the second tooth 111 has a protrusion 111a in a tip and in protuberance relative to the inner flank 111c, and not a curved portion continuous with the inner flank 111c, as in FIG. 2b or 3b.

Advantageously, the first escape wheel 12 and the second escape wheel 22 are perforated as much as possible in order to minimize their inertia. Particularly, the first teeth 121, 221 are perforated. The hub of the wheels 12, 22 is also perforated. The small thickness EDDPr1 of the second teeth 111; 211 greatly contributes to minimizing the inertias of the first escape wheel 12 and of the second escape wheel 22, while allowing the desired number of first teeth to be placed with respect to the operation of the escapement in which the wheels take part.

The first escape wheel 12 and the second escape wheel 22 are preferably obtained by a micro-manufacturing technique, for example by laser cutting, particularly by femtosecond laser, or by deep reactive ion etching (DRIE), or by LIGA.

The first escape wheel 12 and the second escape wheel 22 may comprise all or part of monocrystalline silicon regardless of its orientation, polycrystalline silicon, amorphous silicon, amorphous silicon dioxide, doped silicon regardless of the type and level of doping, or porous silicon. They may also comprise silicon carbide, glass, ceramic, quartz, ruby or sapphire. Alternatively, they may be made of metal or metal alloy, in particular an at least partially amorphous metal alloy. For example, these wheels may comprise nickel Ni or a nickel-phosphorus alloy NiP. It may be provided that the first escape wheel 12 and the second escape wheel 22 are made of different materials.

### INDUSTRIAL APPLICATION

An escapement device according to the present invention, and its manufacture, are suitable for industrial application.

It will be understood that various modifications and/or improvements obvious to those skilled in the art can be made to the different embodiments of the invention described in the present description without departing from the scope of the invention.

Particularly, it is possible to provide that the first escape wheel 12 and the second escape wheel 22 are different from each other, both from the point of view of the dimensions of the hub or of the interface with the shaft onto which they will be added, and of the materials.

It is also possible to provide for using at least one of the escape wheels described above in any other type of escapement, such as for example a natural or direct impulse escapement.

The second teeth may not be symmetrical in pairs and/or may not have a constant or almost constant thickness over their entire height.

1. An escapement device of a timepiece, arranged to receive a drive force from a drive train of the timepiece and transmit impulses to maintain oscillations of an oscillator of the timepiece, the escapement device comprising:
a first escape wheel, pivotally mounted about a first axis of rotation, comprising a toothing equipped with first teeth arranged to at least transmit the impulses to maintain the oscillations of the oscillator, and with second teeth,
a second escape wheel, pivotally mounted about a second axis of rotation, comprising a toothing arranged to at least transmit the impulses to maintain the oscillations of the oscillator and to cooperate with the second teeth of the first escape wheel,
wherein each second tooth of the first escape wheel has an arm shape comprising at least one extreme protrusion arranged to cooperate with the toothing of the second escape wheel.

2. The escapement device according to claim 1, wherein the toothing of the second escape wheel comprises first teeth arranged to at least transmit the impulses to maintain the oscillations of the oscillator, and second teeth arranged to cooperate with the toothing of the first escape wheel, wherein each second tooth of the second escape wheel has an arm shape comprising at least one extreme protrusion arranged to cooperate with the toothing of the first escape wheel.

3. The escapement device according to claim 2, wherein:
the second teeth of the first escape wheel are arranged to cooperate with the first teeth of the second escape wheel, the cooperation between a second tooth of the first escape wheel and a first tooth of the second escape wheel occurring exclusively by the extreme protrusion of said second tooth of the first escape wheel,
and/or
the second teeth of the second escape wheel are arranged to cooperate with the first teeth of the first escape wheel, the cooperation between a second tooth of the second escape wheel and a first tooth of the first escape wheel occurring exclusively by the extreme protrusion of said second tooth of the second escape wheel.

4. The escapement device according to claim 2, wherein:
the extreme protrusion of each second tooth of the first escape wheel is provided to cooperate exclusively with the first teeth of the second escape wheel,
and/or
the extreme protrusion of each second tooth of the second escape wheel is provided to cooperate exclusively with the first teeth of the first escape wheel.

5. The escapement device according to claim 1, comprising a blocking mobile element provided to:
reversibly block the rotation of the first escape wheel and/or of the second escape wheel,
receive the impulses from the first escape wheel and/or from the second escape wheel to transmit them to the oscillator and thus maintain the oscillations of said oscillator.

6. The escapement device according to claim 5, wherein the first teeth of the first escape wheel have tips that cooperate exclusively with the blocking mobile element,
wherein the first teeth of the second escape wheel have tips that cooperate exclusively with the blocking mobile element.

7. The escapement device according to claim 1, wherein each at least one extreme protrusion of the first escape wheel has a first engagement portion arranged to come into contact with the toothing of the second escape wheel during the cooperation of each second tooth of the first escape wheel with the toothing of the second escape wheel,
and wherein each first engagement portion is arranged between two circles of diameter DTDD1 and 0.94.DTDD1, preferably between two circles of diameter DTDD1 and 0.96.DTDD1, preferably between two circles of diameter DTDD1 and 0.98.DTDD1, DTDD1 being a head circle diameter of the second teeth (111) of the first escape wheel.

8. The escapement device according to claim 7, wherein each first engagement portion comprises:
at least one rounded, preferably convex and/or protruding, surface and/or
at least one planar surface, and/or
at least one ridge.

9. The escapement device according to claim 1, wherein each second tooth of the first escape wheel has at least one second engagement portion provided to come into contact with the toothing of the second escape wheel during the cooperation of each second tooth of the first escape wheel with the toothing of the second escape wheel,
and wherein the second engagement portions are arranged at least partially between two circles of diameter DTDD1 and 0.50.DTDD1, preferably between two circles of diameter 0.95.DTDD1 and 0.60.DTDD1, preferably between two circles of diameter 0.90.DTDD1 and 0.70. DTDD1, DTDD1 being a head circle diameter of the second teeth of the first escape wheel.

10. The escapement device according to claim 9, wherein each second tooth of the first escape wheel has a first flank and a second flank opposite to each other, and wherein said at least one extreme protrusion is arranged on or on a side of the first flank, and said at least one second engagement portion is arranged on or on a side of the second flank, each second engagement portion comprising in particular at least one convex contact surface.

11. The escapement device according to claim 1, wherein a first tooth thickness EPDPr1 measured at an average first tooth diameter DPrPD1 is strictly greater than a second tooth thickness EDDPr1 measured at an average second tooth diameter DPrDD1, and preferably 3. EDDPr1<EPDPr1, and preferably 3.5. EDDPr1<EPDPr1.

12. The escapement device according to claim 1, wherein the second teeth of the first escape wheel are arranged in pairs between the first teeth of the first escape wheel,
and particularly, wherein two adjacent second teeth of the first escape wheel are symmetrical relative to a plane of symmetry comprising the first axis of rotation of the first escape wheel.

13. The escapement device according to claim 1, wherein the first tooth head diameter DTPD1 is strictly greater than the second tooth head diameter DTDD1.

14. The escapement device according to claim 1, wherein the toothing of the first escape wheel is identical to the toothing of the second escape wheel.

15. A timepiece, comprising at least one escapement device according to claim 1.
